(19) United States
(12) Patent Application Publication
(10) Pub. No.: US 2002/0131812 A1
(43) Pub. Date: Sep. 19, 2002

(54) Binder insert with a marginal memo area

(76) Inventor: Masaaki Nakaji, Osaka (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 10/037,726

(22) Filed: Oct. 19, 2001

(30) Foreign Application Priority Data
Oct. 20, 2000 (JP) 2000-320948

(51) Int. Cl. B42F 13/00

(52) U.S. Cl. 402/79

(57) ABSTRACT

The present invention provides a binder insert with a marginal memo area, whereby pulling a film up and writing memos in the marginal memo area are facilitated. The binder insert with a marginal memo area is comprised of a body made by folding such as a board-paper at the center thereof in two and adhering facing pages thereof, nondrying adhesive applied on both front and back surfaces of the body leaving a margin at a binding side of the body, a marginal memo area provided on the margin, and a transparent synthetic resin film covering the front and back surfaces of the body starting from a folding side. A binder insert having the above composition provides a means for extending free-end portion of the film slightly to the binding side or an end of the binding side of the body beyond the nondrying adhesive applied portion.

### FIELD OF THE INVENTION

This invention relates to a binder insert, wherein a transparent synthetic resin film covers both front and back surfaces of a body of the binder insert where re-peelable nondrying adhesive is pre-applied on, and particularly to a binder insert having a marginal memo area provided within a part of the insert body.

### DESCRIPTION OF THE PRIOR ART

There already exists an album, wherein re-peelable nondrying adhesive is applied on both front and back surfaces of a binder insert and a transparent synthetic resin film covers the surfaces. Also, a binder insert having a marginal memo area provided within a part of a body of the binder insert has been widely known. As examples of conventional binder inserts, JP Open Gazette for Utility Model Nos. S61-12768 and S56-140478 can be referred.

JP S61-12768 discloses a binder insert having a marginal memo area in a binding side within a binding portion provided through a joint sheet, and a film provided adjacent to the marginal memo area. In this binder insert, a comer end of the film is to be positioned halfway along the lower side of a body, whereby it can be difficult to engage and pull up the film with one's fingertips.

The invention in JP S61-1276 relates to a binder insert, wherein a marginal memo area is provided on a surface of a joint sheet by widening the joint sheet to connect a body and a binding portion. However, when sufficient space is apportioned for the marginal memo area in said joint sheet, the width of said joint sheet becomes too broad so as to interfere with its function as a hinge. In short, since a wide-board hinge will bend and sway harder when each page of an album is turned over, performance of turning pages becomes unstable. Also, as an opening side of the binder insert bends low by a load thereof while the album is kept upright in a bookshelf, the joint sheet will have crinkles therein. Such crinkles developed in said marginal memo area are unsightly and cause difficulties in writing and reading memos.

The invention in JP S56-140478 relates to a binder insert, wherein a photo mounting portion is provided in the upper section where a nondrying adhesive is applied and a transparent film is covered thereover, and a marginal memo area is provided in the lower section. This binder insert presents a problem in pulling the film up as a comer end of the film is positioned at the center of the binder insert. Further, the marginal memo area provided in the lower section causes a difficulty in writing as well. As each binder insert has thickness resulting in wide gap between the marginal memo area and a desk surface, memos cannot be written smoothly in a closed state.

As described above, conventional binder inserts may present a problem in pulling a film up because of the structure thereof, whereby a comer end of a film is positioned halfway along the lower side of a binder insert. Writing a memo is difficult as well. Accordingly, an object of the present invention is to provide a binder insert with a marginal memo area enabling one to pull a film up and to write a memo easily.

### SUMMARY OF THE INVENTION

To solve the above problem, the present invention adopts a binder insert with a marginal memo area comprising a body made by folding such as a board-paper at the center thereof in two and adhering a couple of facing surfaces thereof, nondrying adhesive applied on both front and back surfaces of the body while leaving a margin at a binding side of the body, a marginal memo area provided on the margin, and a transparent synthetic resin film starting to cover the front and back surfaces of the body from a folding side.

In the binder insert, a means for extending a free-end portion of the film slightly to the binding side beyond the nondrying adhesive applied portion or to an end of the binding side is adopted.

The binder insert with a marginal memo area has an advantage in that it is easier to engage and pull up a film with fingertips because the free-end portion is apart from the body.

Also, as the binder insert with a marginal memo area allows one to write memos with an arm resting on the film, a user can write memos without feeling a gap.

In the binder insert with a marginal memo area, a means for providing a notch at the lower side of the body where the notch is overlapped with the free-end portion or where the notch is covered with the film is further adopted.

With the notch, pulling the film up is further facilitated as there is no body under the free-end portion.

A binder insert with a marginal memo area comprising a body made by folding such as a board-paper at the center thereof in two and adhering a couple of facing surfaces thereof, nondrying adhesive applied on both front and back surfaces of the body leaving margins at the upper and lower sides, a marginal memo area provided on the margin of the upper side, and a transparent synthetic resin film starting to cover the front and back surfaces of the body from a folding side is also provided.

In the binder insert with a memo, a means for extending the upper side of the film slightly to an upward direction over the nondrying adhesive applied portion or to the upper side of the body is adapted.

The binder insert is advantageous in that it facilitates catching and pulling up the film with one's fingertips because the upper and lower sides of the film are apart from the body.

Also, since the binder insert with a marginal memo area allows writing memos with an arm resting on said film, a user can write memos without feeling a gap.

In the binder insert with a marginal memo area, a means for providing a notch in a corner end at the binding side of the body is further provided.

With the notch, pulling the film up is further facilitated as there is no body under the free-end portion.

Abovementioned each binder insert can provide an album capable of having horizontal facing pages as opened with a serpentine binding using a joint-paper which is preliminarily folded into a serpentine shape to have sheer sides.

A binder insert with a marginal memo area comprising a body made of a piece of board-paper, nondrying adhesive applied on both front and back surfaces of the body leaving a margin at a binding side, a marginal memo area provided on the margin, a transparent synthetic resin film starting to cover the front and back surfaces of the body from an opening side, holes provided within the binding side of the body, and a notch provided at the lower side of the body, is described.

A means for extending a free-end portion of the film slightly to the binding side over the nondrying adhesive applied portion is also provided.

In addition to foregoing advantages, a binder insert with a marginal memo area having the above construction is capable to be bound in such as a binder through holes.

A binder insert with a marginal memo area comprising a body made by folding such as a board-paper at the center thereof in two and adhering facing surfaces thereof, nondrying adhesive applied on both front and back surfaces of the body leaving a margin at a binding side, a marginal memo area provided on the margin portion, a transparent synthetic resin film starting to cover the front and back surfaces of the body from a folding side, a binding section linked with a hinge and put between the body in the binding side, screw holes provided within the binding section, and a notch provided at the lower side of the body, is further provided.

A means for extending a free-end portion of the film slightly to the binding side over the nondrying adhesive applied portion is also provided.

A binder insert with a marginal memo area having the above construction is, in addition to foresaid advantages, capable to be bound together with front and back covers of an album utilizing screw holes.

### BRIEF DESCRIPTION OF THE DRAWINGS

FIG. 1A is a front view of an embodiment of a binder insert in accordance with the present invention;

FIG. 1B is a laterally sectioned view of the binder insert of FIG. 1A;

FIG. 2A is a front view of a second embodiment of a binder insert in accordance with the present invention;

FIG. 2B is a laterally sectioned view of the binder insert of FIG. 2A;

FIG. 3A is a front view of a third embodiment of a binder insert in accordance with the present invention;

FIG. 3B is a laterally sectioned view of the binder insert of FIG. 3A;

FIG. 4A is a front view of a fourth embodiment of a binder insert in accordance with the present invention;

FIG. 4B is a laterally sectioned view of the binder insert of FIG. 4A;

FIG. 5A is a front view of a fifth embodiment of a binder insert in accordance with the present invention;

FIG. 5B is a laterally sectioned view of the binder insert of FIG. 5A;

FIG. 5C is a vertically sectioned view of the binder insert of FIG. 5A;

FIG. 6A is a front view of a sixth embodiment of a binder insert in accordance with the present invention;

FIG. 6B is a laterally sectioned view of the binder insert of FIG. 6A;

FIG. 6C is a vertically sectioned view of the binder insert of FIG. 6A;

FIG. 7A is a front view of a seventh embodiment of a binder insert in accordance with the present invention;

FIG. 7B is a laterally sectioned view of the binder insert of FIG. 7A;

FIG. 7C is a vertically sectioned view of the binder insert of FIG. 7A;

FIG. 8A is a front view of an album bound with a serpentine binding being double spread;

FIG. 8B is a bottom view of the album of FIG. 8A;

FIG. 9 is a partly omitted sectional view showing a structure of a serpentine binding;

FIG. 10 illustrates an eighth embodiment of a binder insert in accordance with the present invention;

FIG. 11A illustrates a front view of a ninth embodiment of a binder insert in accordance with the present invention;

FIG. 11B illustrates a laterally sectioned view of the binder insert of FIG. 11A;

FIG. 12A illustrates a front view of a tenth embodiment of a binder insert in accordance with the present invention; and

FIG. 12B illustrates a laterally sectioned view of the binder insert of FIG. 12A.

### DETAILED DESCRIPTION OF THE PREFERRED EMBODIMENT

Hereafter, several preferred embodiments of a binder insert in accordance with the present invention will be described with reference to the drawings.

Embodiment 1

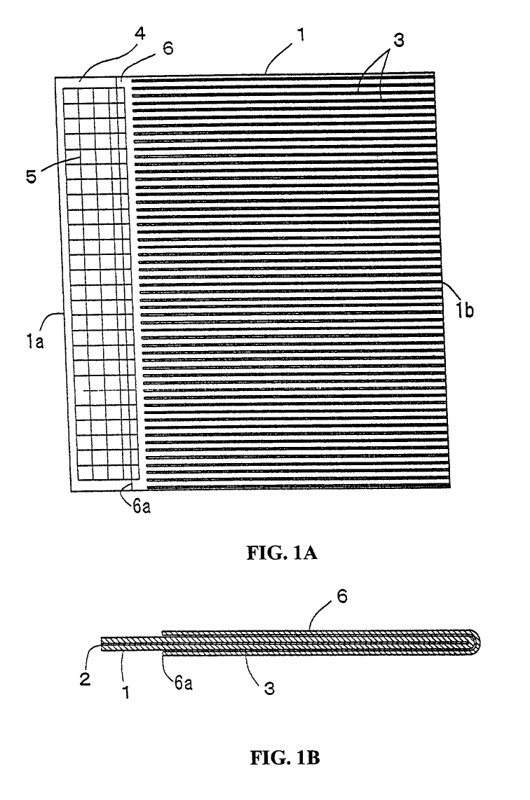

FIG. 1A is a front view and FIG. 1B is a laterally sectioned view of a first embodiment of a binder insert in accordance with the present invention. As shown in FIG. 1, the binder insert comprises a body 1 made by folding such as a board-paper of required size in two at the center thereof and adhering facing pages thereof with adhesive 2. Nondrying adhesive 3 is applied on both front and back surfaces of the body 1 with a strip pattern leaving a margin 4 of required width at a binding side 1a of the body 1. The nondrying adhesive 3 enables one to attach and detach pictures repeatedly. A marginal memo area 5 of checked pattern is printed on the margin 4 to write a photography record and the like. A transparent synthetic resin film 6 covers the front and back surfaces of the body 1 starting from a folding side 1b. A free-end portion 6a is slightly extended to the binding side 1a beyond the nondrying adhesive 3 applied portion to be apart from the body 1 in order to prevent the film 6 from being clung onto the body 1.

As explained above, the film 6 is easily caught and pulled up with fingertips because the free-end portion 6a is separated from the body 1. Also, a user can easily write memos with his/her arm resting on the film without feeling a gap. Further, a mounted photo as protected and covered with the film 6 is protected from damage.

Embodiment 2

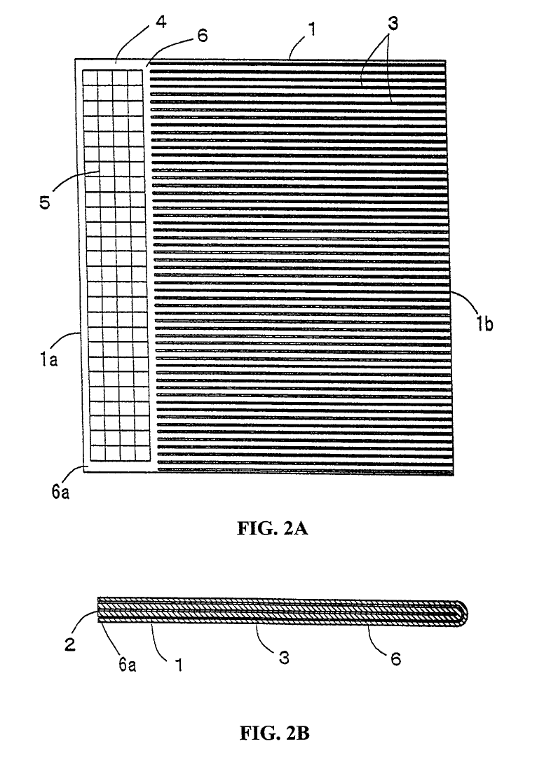

FIG. 2 shows the second embodiment of a binder insert in accordance with the present invention. FIG. 2A is a front view of the binder insert and FIG. 2B is a laterally sectioned view of the binder insert. In FIG. 2, the composition of said binder insert is the same as that of Embodiment 1: 1 is a body, 2 is adhesive, 3 is nondrying adhesive, 4 is a margin, and 5 is a marginal memo area. However, as disclosed in the sectioned view, a transparent synthetic resin film 6 covering the body 1 is covering the whole marginal memo area by extending a free-end portion 6a thereof to an end of a binding side 1a of the body 1.

Compared to Embodiment 1, the free-end portion 6a of the film 6 in a binder insert having the above construction is so floated from body 1 that pulling up film 6 is further facilitated. Also, since the whole surface of the marginal memo area 5 is covered with film 6, the marginal memo area is effectively protected from damage.

Embodiment 3

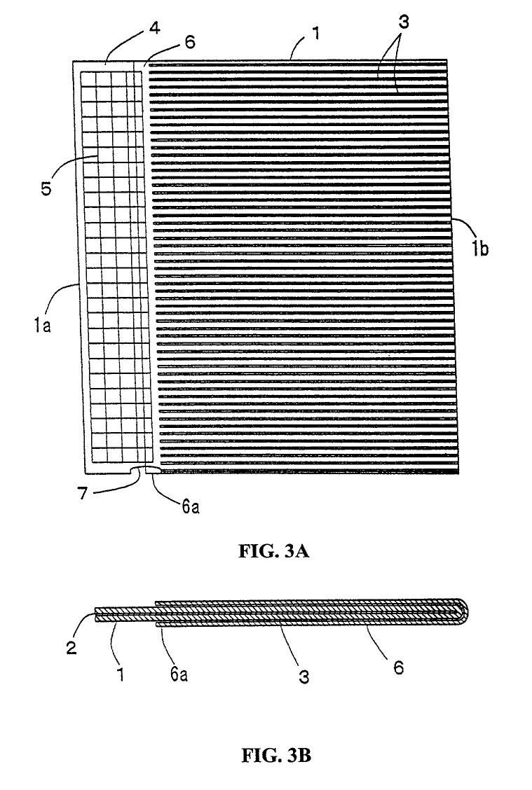

A binder insert in FIG. 3 with the same composition as that of Embodiment 1 has a notch 7 provided at the lower side of body 1 where a free-end portion 6a of film 6 is overlapped with notch 7.

The binder insert, wherein there is no body 1 underneath the corner of the free-end portion 6a, greatly facilitates to grasping free-end portion 6a and pulling up the film 6 with one's fingertips.

Embodiment 4

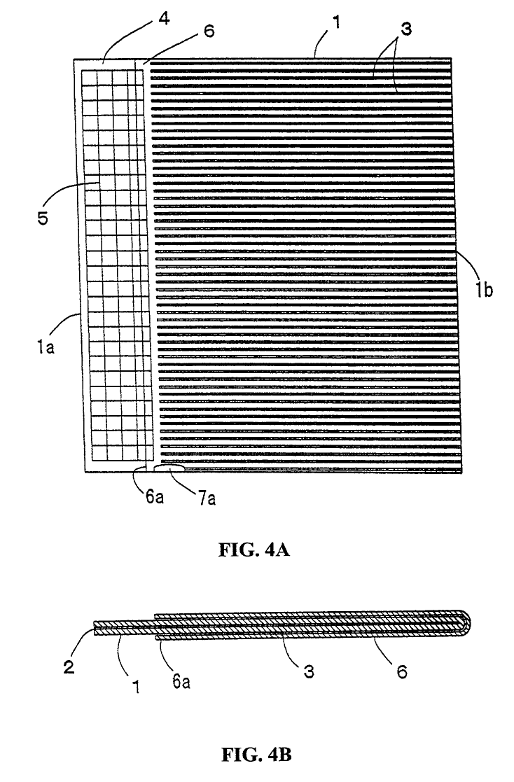

A binder insert in FIG. 4 with the same composition as that of Embodiment 1 has a notch 7a provided at the lower side of body 1 like in Embodiment 3. However, the position of notch 7a is different from that of Embodiment 3 and slightly moved from the corner of a free-end portion 6a to the opposite direction, whereby notch 7a does not overlap with the corner of the free-end portion 6a.

In the case of Embodiment 3, repeated performance of pulling a film up may cause curl in the free-end portion 6a of the film. The binder insert in FIG. 4 has changed the position of notch 7a to prevent such curl without losing the advantage of facilitating pulling the film up.

Embodiment 5

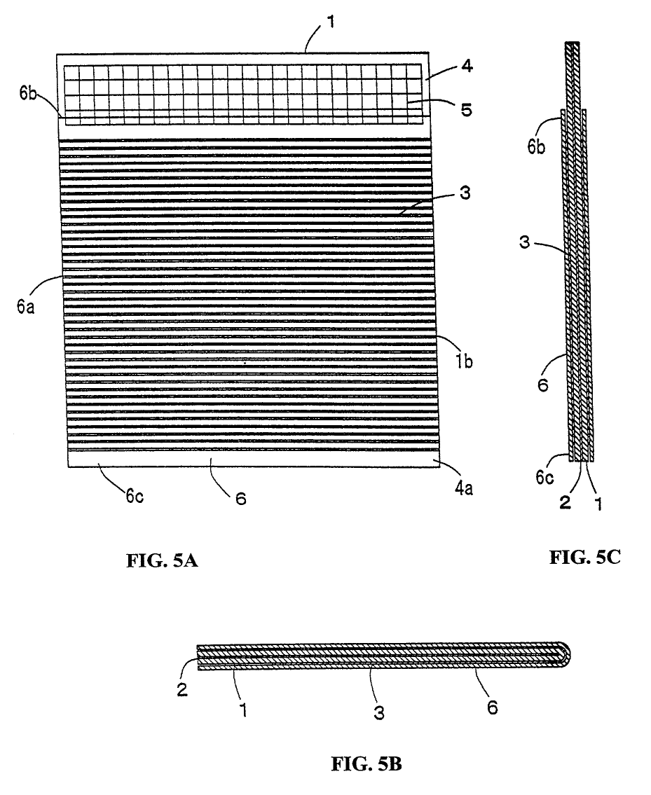

FIG. 5 shows a farther embodiment of a binder insert, wherein a marginal memo area 5 is provided on the upper portion of body 1. FIG. 5A is a front view of the binder insert, FIG. 5B is a laterally sectioned view of the binder insert, and FIG. 5C is a vertically sectioned view of the binder insert. In FIG. 5, 1 is a body made by folding such as a board-paper of required size in two at the center thereof and adhering facing pages thereof with adhesive 2. Nondrying adhesive 3 is applied on both front and back surfaces of body 1 with a strip pattern leaving a margin 4 of required width at the upper side and a margin 4a of required width at the lower side of body 1. On margin 4 provided at the upper side, a marginal memo area 5 of checked pattern is printed. A transparent synthetic resin film 6 covers the front and back surfaces of body 1 starting from a folding side 1b of body 1. The upper side 6b of film 6 is slightly extended in an upward direction beyond the nondrying adhesive 3 applied portion to create a state that the upper side 6b is slightly floated from the body 1 to prevent film 6 from being attached with body 1. The lower side 6c of the film 6 is slightly floated from body 1 as well.

A binder insert having the above construction facilitates pulling the film 6 up as the upper or the lower left corner of the free-end portion 6a is apart from body 1. Also, since the binder insert allows writing memos with an arm resting on the film, a user can easily write memos without feeling a gap.

Embodiment 6

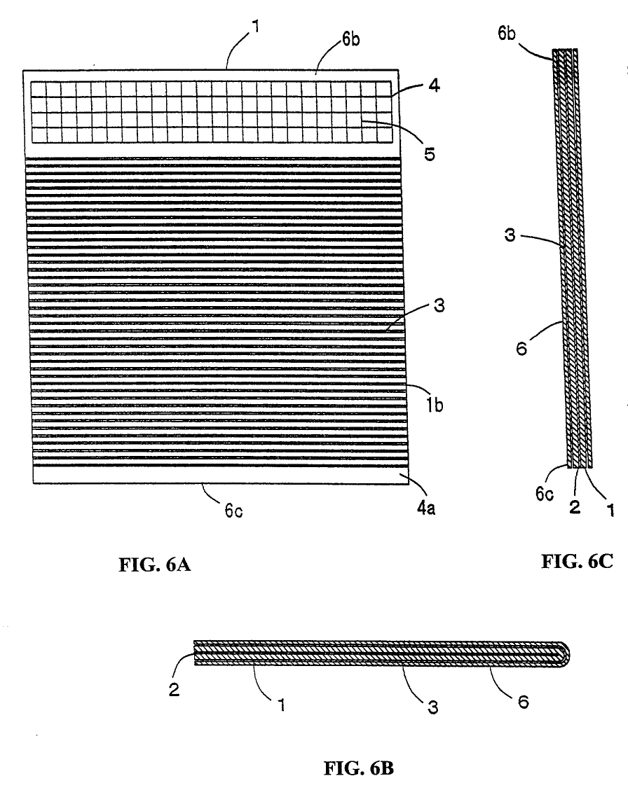

A binder insert in FIG. 6 with the same composition as that of Embodiment 5 has a transparent synthetic resin film 6 covering the whole surface of a marginal memo area 5 by extending an upper side 6b thereof.

Since the upper side 6b or a lower side 6c of the film in the binder insert is apart from the body 1, the film 6 is easily pulled up. Also, the whole marginal memo area 5 is covered with film to protect it from damage or stain.

Embodiment 7

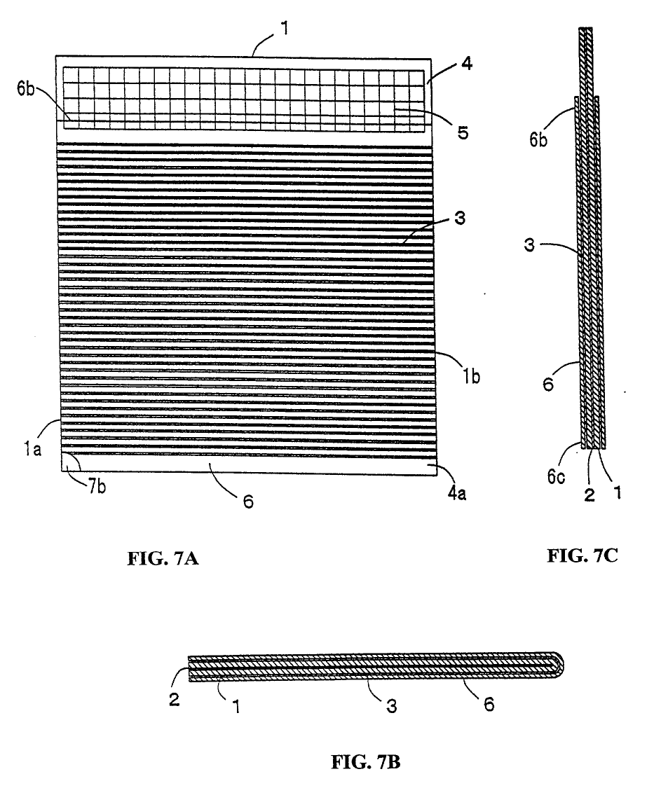

A binder insert in FIG. 7 with the same composition as that of Embodiment 5 has a notch 7b provided at the lower comer of a binding side 1 a in a body 1.

Notch 7b facilitates the ability for fingertips to catch a corner of film 6 and to pull the film up.

As described above, the present invention provides a binder insert having a margin at binding side or the upper side of a body where nondrying adhesive is not applied for using the margin as a marginal memo area. Also, in the binder insert, a transparent synthetic resin film covers the body over the nondrying adhesive applied portion to facilitate in pulling the film up by floating an end of the film from the body.

A marginal memo area for writing photography records and the like is not limited to a checked pattern as disclosed in the drawings. For example, horizontal lines only or square frame lines may be adapted. Gradation print may be further adapted for facilitation in writing memos.

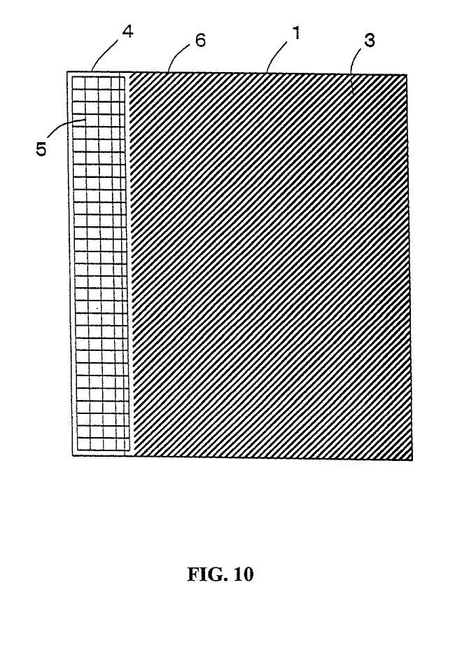

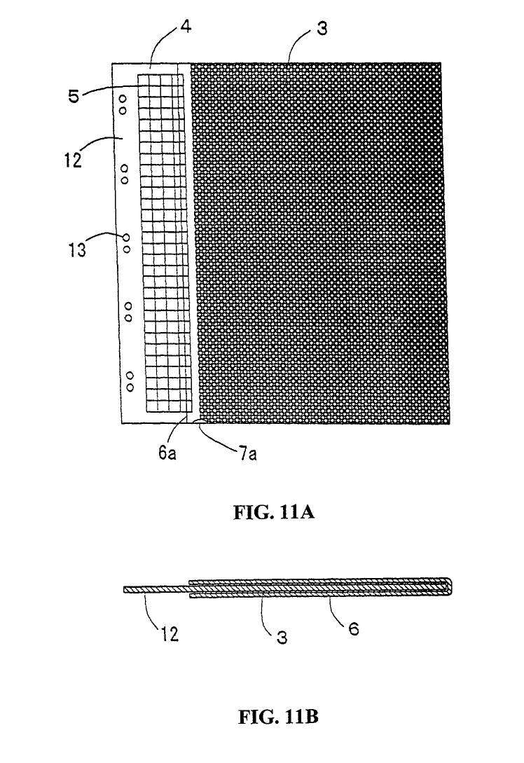

As to applying patterns of nondrying adhesive, not only a lateral strip but also a vertical strip, diagonal line as shown in FIG. 10, checked (meshed) pattern as shown in FIG. 11, or other conventional patterns may be adapted.

Hereafter, a binding method of an album using a binder insert in accordance with the present invention is discussed. A binder insert as described in Embodiment 1 is used.

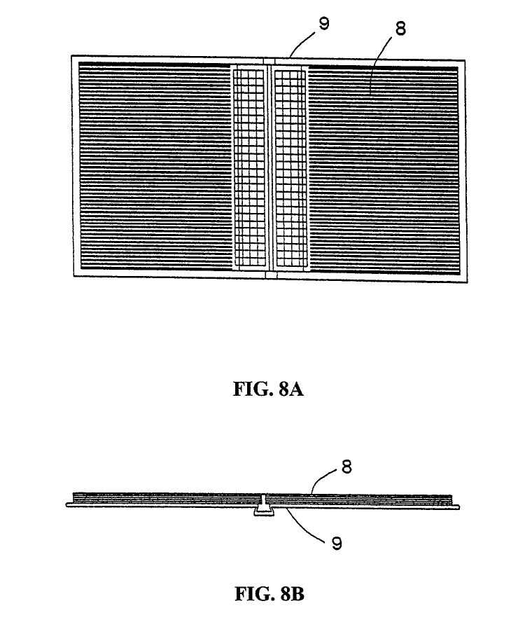

FIG. 8 shows an album bound by way of a serpentine binding. FIG. 8A is a front view of the album being double-spread, and FIG. 8B is a bottom view of the album. FIG. 8 shows a binder insert 8 and a cover 9. Double-spread pages are to be flat with a serpentine binding, whereby a user can comfortably see photographs and write memos.

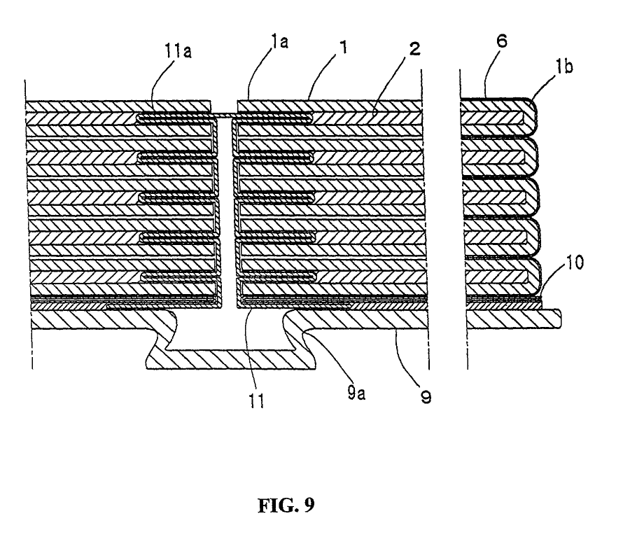

FIG. 9 is a partly omitted sectional view showing the structure of the serpentine binding. As shown in FIG. 9, a body 1 is made by folding such as a board-paper of required size at the center thereof and adhering facing pages thereof with adhesive 2. A transparent synthetic resin film 6 covers both front and back surfaces of the body from a folding side 1b of the body 1. Nondrying adhesive to be applied on the body which is shown in FIG. 1 is omitted in this figure. A cover 9, a back paper 10 adhered on a back surface of the cover 9, and a reinforcement paper 11 to link a plurality of mounts are also illustrated.

In accordance with a serpentine binding procedure, the reinforcement paper made of a strong thin paper is first folded to a serpentine shape and then facing back surfaces of folded portions are adhered together to form a plurality of folded portions 11a having vertical serpentine shape. Next, the folded portion 11a having a vertical serpentine shape is inserted between the body 1 at a binding side 1a and adhered to the body 1. After combining a predetermined number of the body 1 with each of the folded portions 11a, right and left ends of the reinforcement paper 11 are adhered to the inside of a ravine portion 9a of the cover 9. Further, the back paper 10 folded in two is adhered onto the back surface of the cover 9 sheathing reinforcement 11. The serpentine binding is completed with the above procedures.

The above binding method provides a binder or album wherein the folded portion having a vertical serpentine shape, which is folded into two, is inserted between body. Therefore, ravine portion 9a is bulged after binding and the album tapers off toward the opening side. However, the width of the body is increased by mounting photographs, whereby the whole width of the album is well-proportioned.

Although the same kind of binding such as a picture book binding has existed, the serpentine biding procedure provides an album enabling one to see photographs and write memos comfortably by having flat double-spread pages as opened. In short, the serpentine binding can provide a fine album by using the binder insert of the present invention.

Hereafter, other embodiments of a binder insert adaptable to other binding methods are discussed.

Embodiment 8

FIG. 11 illustrates a binder insert to be bound in a binder. FIG. 11A is a front view of the binder insert, and FIG. 11B is a laterally sectioned view of the binder insert. As shown in FIG. 11, a body 12 is made of a piece of board-paper and nondrying adhesive 3 is applied with a strip pattern on both front and back surfaces of the body 12 leaving a margin 4 at a binding side of the body 12. A marginal memo area 5 is printed on the margin 4 with a checked pattern for writing memos such as photography records, and a plurality of holes 13 are provided within ends of the margin 4 for binding. A transparent synthetic resin film 6 covers the front and back surfaces of the body 12 starting from an opening side and a free-end portion 6a thereof is slightly extended to a binding side of the body 12 beyond the nondrying adhesive applied portion to prevent the free-end portion 6a from being attached with the body 12. A notch 7a is provided at the lower side of the body 12.

A binder insert having the above construction facilitates memo writing without feeling a gap allowing a user to write memos with his/her arm resting on the film as in Embodiment 1. Also, the film can be easily pulled up with the free-end portion 6a being apart from the body 12. Notch 7a further facilitates pulling the film up.

Embodiment 9

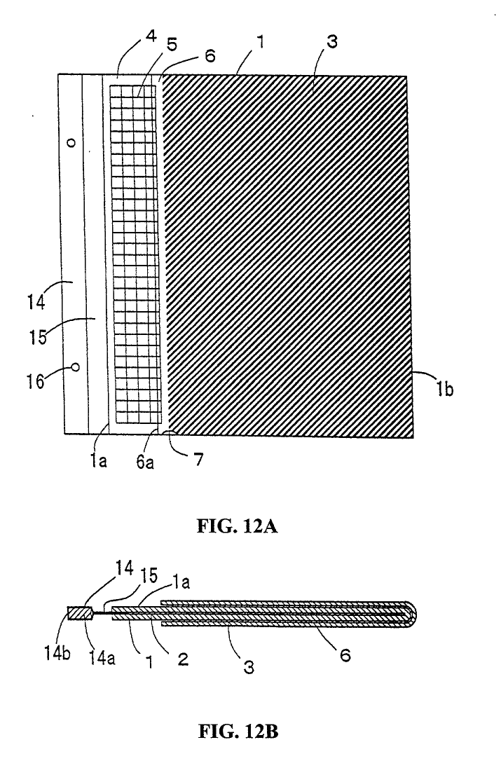

FIG. 12 shows a binder insert to be bound using screws. FIG. 12A is a front view of a binder insert in accordance with this embodiment of the invention and FIG. 12B is a laterally sectioned view of the binder insert. As shown in FIG. 12, a body 1 is made by folding such as a board-paper of required size at the center thereof in two and adhering facing pages thereof with an adhesive 2. A nondrying adhesive 3 is applied on both front and back surfaces of the body 1 with a rakish stripe pattern leaving a margin 4 of required width at a binding side 1a in body 1. A memo 5 of checked pattern is printed on the margin 4 for writing memos such as photography records and the like. A transparent synthetic resin film 6 covers the front and back surfaces of body 1 starting from a folding side 1b of body 1. A free-end portion 6a is prevented from being attached with body 1 by extending thereof slightly to a binding side beyond the nondrying adhesive applied portion. A notch 7 is provided at the lower side of body 1. This composition is basically the same as described in Embodiment 1. A binding section 14 comprises a base 14a and a thin paper 14b sheathing the base 14. A two-ply extension piece includes a hinge portion 15 inserted between the body 1 at the binding side 1a. The binding section 14 provides holes 16 therewithin to fix thereof to a cover with screws.

A binder insert having the above construction also facilitates memo writing, like abovementioned embodiments, without feeling a gap thereby allowing a user to write memos with his/her arm resting on the film. Also, the film is easily pulled up as the free-end portion 6a is apart from the body 1. Notch 7 further facilitates pulling the film up.

In the binder insert bound by a binder or bound using screws, the marginal memo area is printed on the margin provided within the binding side. However, the marginal memo area is not limited to that position, but may be provided within the upper side of the body 1 as shown in Embodiment 5. The same advantage can be obtained even in the above composition using the binder inserts in accordance with the present invention.

As described above, a binder insert in the present invention is expected to augment the practical value of an album enabling the user to record various kinds of information such as photography records on a marginal memo area along with photographs owing to a composition thereof having a margin provided within the upper side at a binding side of a body where nondrying adhesive is not applied for using the margin as a marginal memo area.

One advantage of the present invention is that by providing an end-free portion of the film apart from the body, a user can easily grasp and pull up the film. The film is pulled up more easily by further providing a notch.

Further, an advantage of facilitating writing memos is expected with the marginal memo area provided on the margin in the body allowing a user to write memos resting his/her arm on the film without feeling a gap.

In the case that a board-paper folded in two is used as a body, a serpentine binding album can be provided which facilitates viewing of photographs and writing memos with flat double-spread pages. The same composition can be used to provide a binder insert bound by a binder or bound using screws providing the same advantage.

What is claimed is:

1. A binder insert with a marginal memo area comprising:
a body made by folding a board-paper at the center thereof in two and adhering a couple of facing pages thereof,
nondrying adhesive applied on both front and back surfaces of said body, forming nondrying adhesive portions,
a margin at a binding side of said body free of said nondrying adhesive,
a marginal memo area provided on said margin,
and a transparent synthetic resin film covering said front and back surfaces of said body starting from a folding side of said body.

2. A binder insert with a marginal memo area according to claim 1, wherein a free-end portion of said film is extended slightly to said binding side of said body beyond said nondrying adhesive applied portion.

3. A binder insert with a marginal memo area according to claim 2, wherein said free-end portion of said film is extended to an end of said binding side of said body.

4. A binder insert with a marginal memo area according to claim 1, wherein a notch is provided at a lower side of said body.

5. A binder insert with a marginal memo area according to claim 2, wherein a notch is provided at a lower side of said body.

6. A binder insert with a marginal memo area according to claim 3, wherein a notch is provided at a lower side of said body.

7. A binder insert with a marginal memo area according to claim 5, wherein said notch is provided at the lower side of said body where said free-end portion of said film overlaps therewith.

8. A binder insert with a marginal memo area according to claim 6, wherein said notch is provided at the lower side of said body where said free-end portion of said film overlaps therewith.

9. A binder insert with a marginal memo area according to claim 5, wherein said notch is provided at the lower side of said body where said notch does not overlap with said free-end portion of said film.

10. A binder insert with a marginal memo area comprising:
a body made by folding a board-paper at the center thereof in two and adhering a couple of facing pages thereof,
nondrying adhesive applied on both front and back surfaces of said body forming nondrying adhesive portions leaving margins at upper and lower sides of said body free of nondrying adhesive,
a marginal memo area provided on said upper margin,
and a transparent synthetic resin film covering said front and back surfaces of said body starting from a folding side of said body.

11. A binder insert with a marginal memo area according to claim 10, wherein an upper side of said film is slightly extended in an upward direction beyond said nondrying adhesive applied portion.

12. A binder insert with a marginal memo area according to claim 10, wherein an upper side of said film is extended to the upper side of said body.

13. A binder insert with a marginal memo area according to claim 10, wherein a notch is provided at a lower comer at a binding side of said body.

14. A binder insert with a marginal memo area according to claim 1, wherein a notch is provided at a lower comer at a binding side of said body.

15. A binder insert with a marginal memo area according to claim 12, wherein a notch is provided at a lower comer at a binding side of said body.

16. A binder insert with a marginal memo area comprising;
a body made of a piece of board-paper,
nondrying adhesive applied on both front and back surfaces of said body leaving a margin at a binding side of said body,
a marginal memo area provided on said margin,
a transparent synthetic resin film covering said front and back surfaces of said body starting from an opening side of said body,
a plurality of holes provided at said binding side of said body,
and a notch provided at a lower side of said body.

17. A binder insert with a marginal memo area according to claim 16, wherein a free-end portion of said film is slightly extended to said binding side of said body beyond said nondrying adhesive applied portion.

18. A binder insert with a marginal memo area comprising;
a body made by folding a board-paper at the center thereof in two and adhering facing pages thereof,
nondrying adhesive applied on both front and back surfaces of said body leaving a margin at a binding side of said body,
a marginal memo area provided on said margin,
a transparent synthetic resin film covering said front and back surfaces of said body starting from a folding side of said body,
a binding section provided by inserting a hinge between said body at said binding side,
a plurality of screw holes provided within said binding section,
and a notch provided at a lower side of said body.

19. A binder insert with a marginal memo area according to claim 18, wherein a free-end portion is slightly extended to said binding side of said body beyond said nondrying adhesive applied portion.
